(19) United States
(12) Patent Application Publication
(10) Pub. No.: US 2002/0040860 A1
(43) Pub. Date: Apr. 11, 2002

(54) Apparatus and method for unattended delivery

(76) Inventors: Dickon Isaacs, Chicago, IL (US); Peter C. Simpson, Lafayette, CO (US); Jerimiah P. O'Leary, Chicago, IL (US); Jonathan I. Kaplan, Palo Alto, CA (US); Mark A. Zeh, Mountain View, CA (US); Steven L. Atkins, Redwood City, CA (US); Hans-Christoph Haenlein, Cupertino, CA (US); Mark Stein, Arlington, VA (US); Timothy J. Ogilvie, New York, NY (US)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 09/832,133

(22) Filed: Apr. 11, 2001

Related U.S. Application Data
(60) Provisional application No. 60/196,086, filed on Apr. 11, 2000.

(51) Int. Cl. B65D 85/00; G08B 13/14

(52) U.S. Cl. 206/459.1; 340/569; 340/574

(57) ABSTRACT

A method for assembling an unattended delivery device is provided. The method includes the steps of fastening a base to a first external surface, in which the base has a first base weight, and fastening a floor to the base. The method further includes the steps of fastening three walls to the floor, fastening a top to the walls, fastening an electronic assembly base to the top, and fastening an electronic assembly to the electronic assembly base. The method also includes the steps of fastening an electronic assembly cover to the walls and attaching a door to one end of one of the walls, in which the door, the walls, the top, and the floor form an enclosure. An apparatus for unattended delivery is provided. The apparatus includes a base fastened to a first external surface, in which the base has a first base weight, a floor fastened to the base, and three walls fastened to the floor. The apparatus further includes a top fastened to the walls, an electronic assembly base fastened to the top, and an electronic assembly fastened to the electronic assembly base. The apparatus also includes an electronic assembly cover fastened to the walls and a door attached to one end of one of the walls, in which the door, the walls, the top, and the floor form an enclosure.

The present application claims priority from U.S. Provisional Patent Application No. 60/196,086, entitled “Device for Unattended Home Delivery and Method for Constructing Thereof,” the disclosure of which is incorporated herein by reference in its entirety.

### BACKGROUND OF THE INVENTION

1. Field of the Invention

The invention relates generally to apparatus and methods for unattended delivery. More specifically, the invention is directed to a method for assembling an unattended delivery device and an apparatus allowing for unattended deliveries to be made at a remote location.

2. Description of Related Art

Consumers today are busier than ever and are challenged to find a sustainable balance between work and family. As a result, consumers have shown a strong willingness to embrace innovations that bring convenience and flexibility to their lives. Two trends that illustrate this phenomenon are (a) telecommuting and other home-based work situations, and (b) convenience-driven, self-service devices and utilities. It is estimated that there are over 10 million workers in the United States who telecommute (i.e., work from home rather than travel to their office to work) more than one day per week. That figure is in addition to the more than 24 million Americans who operate businesses from their homes. It has been estimated that 40 million U.S. households are connected to the Internet at home, and nearly half of these homes use the Internet to purchase goods and services.

Moreover, once goods are purchased, they may be delivered to a remote location. One method of facilitating the delivery of goods to a remote location may be to use an unattended delivery apparatus, such as that described in U.S. Pat. No. 5,774,053, the disclosure of which is incorporated herein by reference in its entirety. The apparatus disclosed in U.S. Pat. No. 5,774,053 may provide a secure enclosure that may enable both inbound delivery and outbound pickup of goods. Similarly, an unattended delivery storage device, such as that described in U.S. Provisional Patent Application No. 60/161,922, filed Oct. 28, 1999, the disclosure of which is incorporated herein by reference in its entirety, may be used.

### SUMMARY OF THE INVENTION

Therefore, a need has arisen for an apparatus and method that overcomes these and other shortcomings of the related art. A technical advantage of the present invention is that an unattended delivery device may be readily and securely assembled. Another technical advantage of the present invention is that the assembled unattended delivery device may allow for the delivery of a package at a remote location.

In an embodiment of the present invention, a method for assembling an unattended delivery device is provided. The method comprises the steps of fastening a base to a first external surface, in which the base has a first base weight, and fastening a floor to the base. The method further comprises the steps of fastening at least one wall to the floor, fastening a top to the wall, fastening an electronic assembly base to the top, and fastening an electronic assembly to the electronic assembly base. The method also comprises the steps of fastening an electronic assembly cover to the wall and attaching at least one door to at least one end of the wall, whereby the door, the at least one wall, the top, and the floor form an enclosure.

In another embodiment of the present invention, an apparatus for unattended delivery is provided. The apparatus comprises a base fastened to a first external surface, in which the base has a first base weight, a floor fastened to the base, and at least one wall fastened to the floor. The apparatus further comprises a top fastened to the wall, an electronic assembly base fastened to the top, and an electronic assembly fastened to the electronic assembly base. The apparatus also comprises an electronic assembly cover fastened to the wall and at least one door attached to at least one end of the wall, whereby the door, the at least one wall, the top, and the floor form an enclosure.

Other objects, features, and advantages will be apparent to persons of ordinary skill in the art in view of the following detailed description of the invention and the accompanying drawings.

### BRIEF DESCRIPTION OF THE DRAWINGS

For a more complete understanding of the present invention, the needs satisfied thereby, and the features and advantages thereof, reference now is made to the following descriptions taken in connection with accompanying drawings.

FIG. 1 is an exploded perspective view of an unattended delivery device according to an embodiment of the present invention.

FIG. 2 is an upper and a lower perspective view of a cover for the device depicted in FIG. 1, according to an embodiment of the present invention.

FIG. 3 is a perspective view of a top wall for the device depicted in FIG. 1, according to an embodiment of the present invention.

FIG. 4 is a perspective view of a wall of the device depicted in FIG. 1, according to an embodiment of the present invention.

FIG. 5 is a perspective view of a wall of the device depicted in FIG. 1, according to an embodiment of the present invention.

FIG. 6 is a perspective view of a wall of the device depicted in FIG. 1, according to an embodiment of the present invention.

FIG. 7 is a perspective view of a corner clip extension for the device depicted in FIG. 1, according to an embodiment of the present invention.

FIG. 8 is a perspective view a floor for the device depicted in FIG. 1, according to an embodiment of the present invention.

FIG. 9 is a bottom view of the floor depicted in FIG. 8, according to an embodiment of the present invention.

FIG. 10 is a bottom view of a floor tray for the device depicted in FIG. 1, according to an embodiment of the present invention.

FIG. 11 is a perspective view of a base for the device depicted in FIG. 1, according to an embodiment of the present invention.

FIG. 12 is an underneath view of the base depicted in FIG. 1, according to an embodiment of the present invention.

FIG. 13 is a front perspective and a rear perspective view of a paddle for the device depicted in FIG. 1, according to an embodiment of the present invention.

FIG. 14 is a perspective view of a door for the device depicted in FIG. 1, as viewed from the inside of the device depicted in FIG. 1, according to an embodiment of the present invention.

FIG. 15 is a perspective view of the outside of the door depicted in FIG. 1, according to an embodiment of the present invention.

FIGS. 16, is a perspective view of a door cover for the device depicted in FIG. 1, according to an embodiment of the present invention.

FIG. 17 is two perspective views of a latching assembly mounting plate for the device depicted in FIG. 1, according to an embodiment of the present invention.

FIG. 18, a perspective view of a latching assembly for the device depicted in FIG. 1, according to an embodiment of the present invention.

FIGS. 19 is a front perspective view of an electronics assembly cover for the device depicted in FIG. 1, according to an embodiment of the present invention.

FIGS. 20A and 20B a rear view and a bottom view of the electronics assembly depicted in FIG. 19, respectively, according to an embodiment of the present invention.

FIG. 21 is an upper perspective view of the base depicted in FIG. 12, according to an embodiment of the present invention.

FIG. 22 is a lower perspective view of the base depicted in FIG. 12, according to an embodiment of the present invention.

FIG. 23 is a perspective view of a battery holding device for the device depicted in FIG. 1, according to an embodiment of the present invention.

FIG. 24 is a flow-chart for a method of assembling an unattended delivery device, according to an embodiment of the present invention.

FIG. 25 is a flow-chart for a method of assembling an unattended delivery device, according to an embodiment of the present invention.

FIG. 26 is a flow-chart for a method of assembling an unattended delivery device, according to an embodiment of the present invention.

FIG. 27 is a flow-chart for a method of assembling a latching assembly for the apparatus depicted in FIG. 26, according to an embodiment of the present invention.

FIG. 28 is a flow-chart for a method of assembling at least one wall of the apparatus depicted in FIGS. 24, 25, or 26, according to an embodiment of the present invention.

### DETAILED DESCRIPTION OF PREFERRED EMBODIMENTS

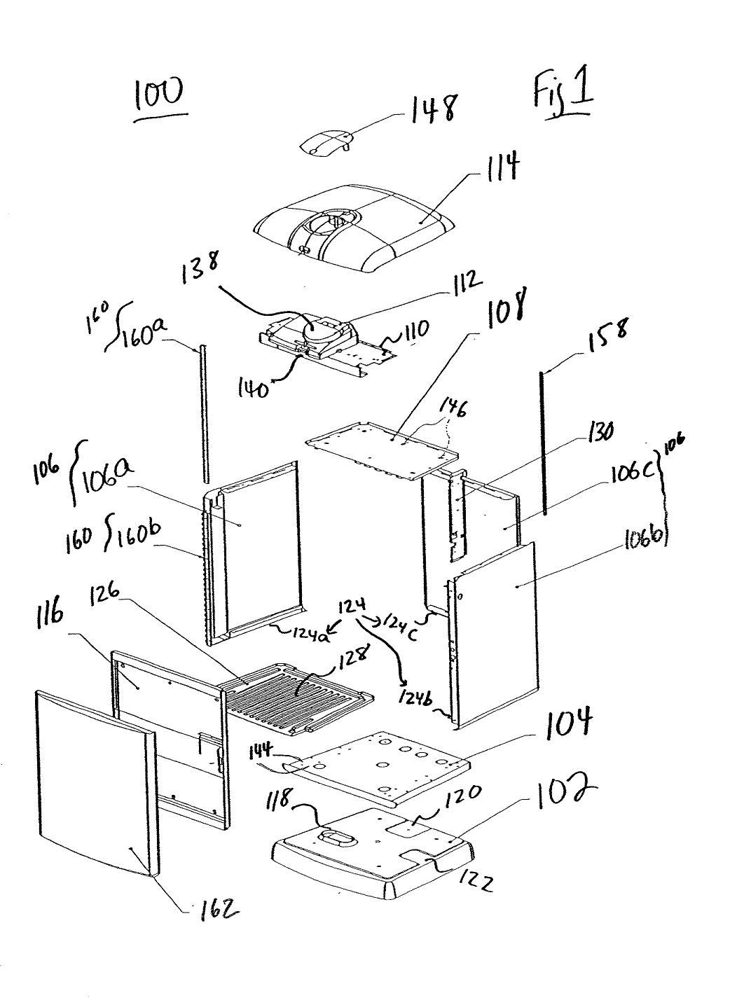

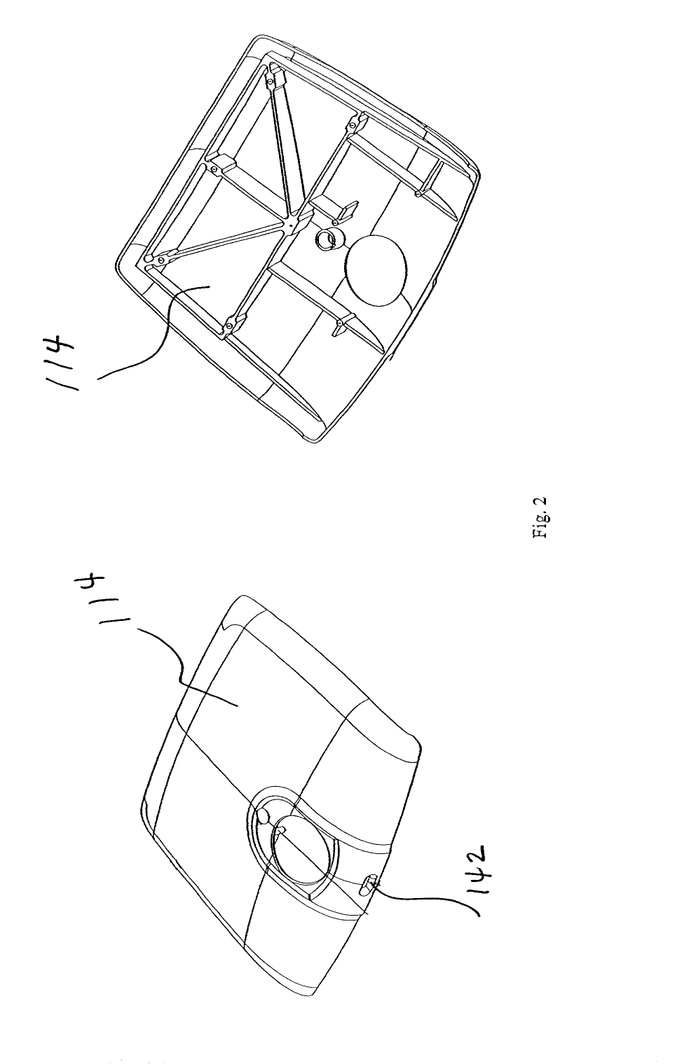

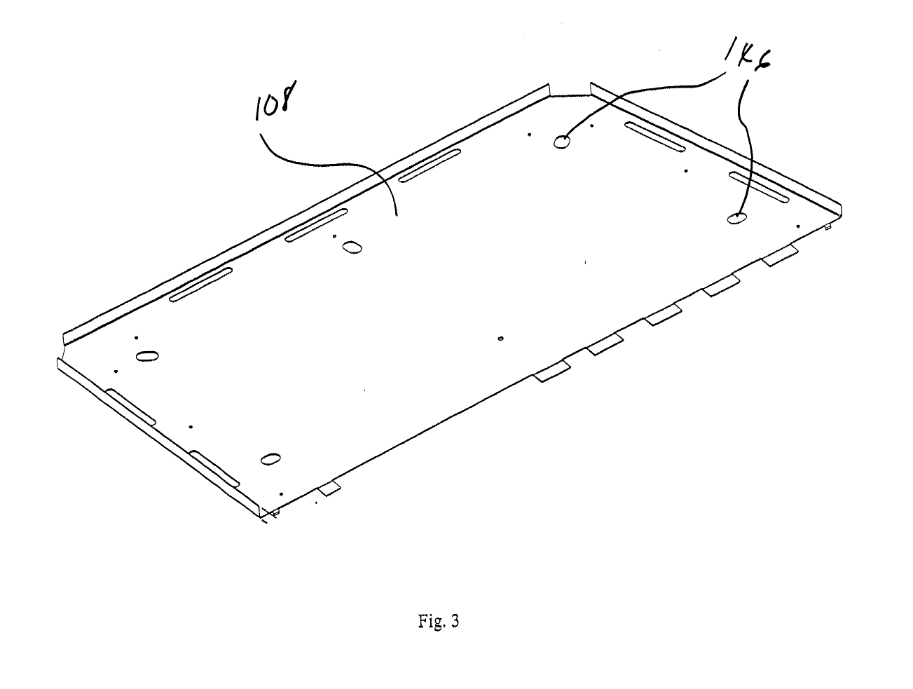

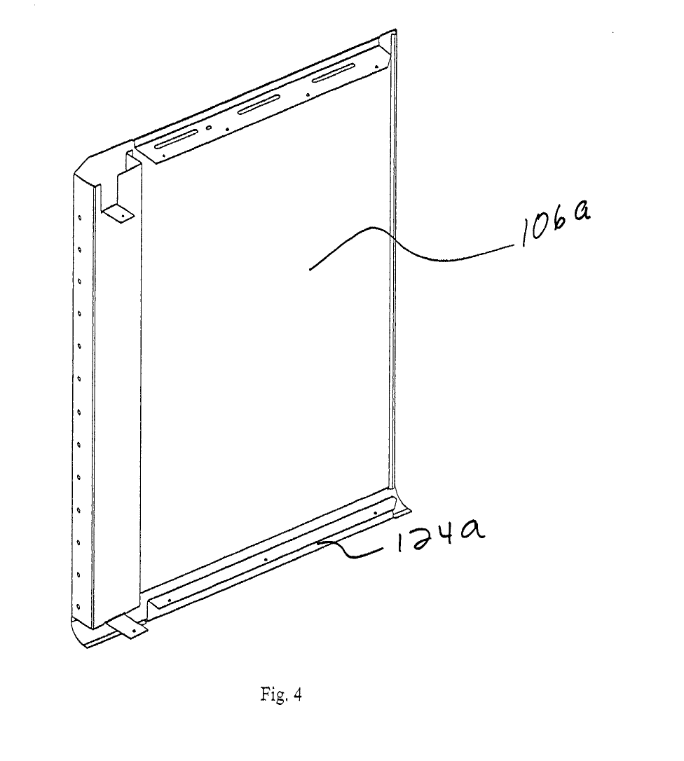

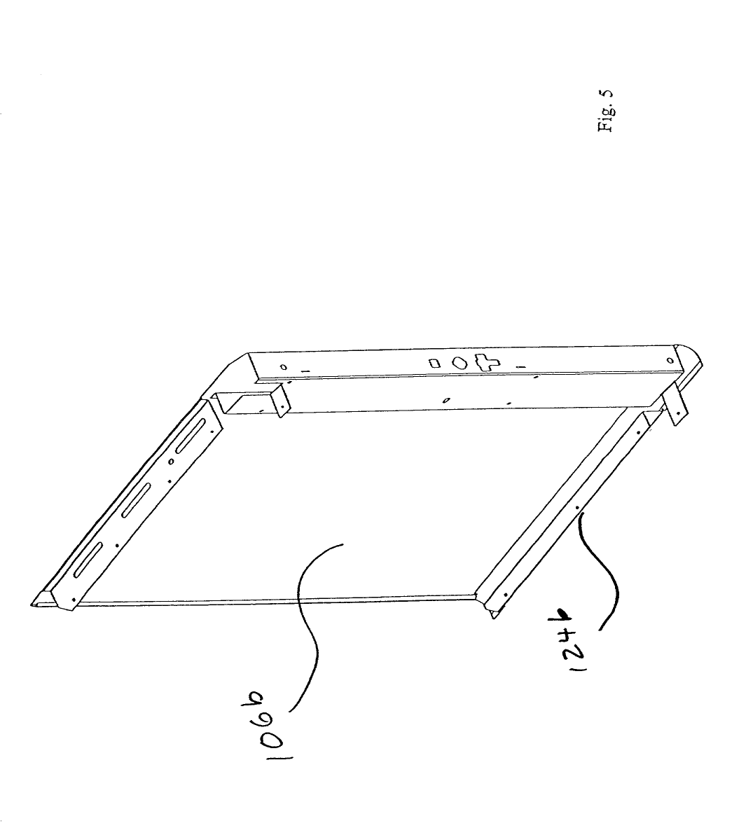

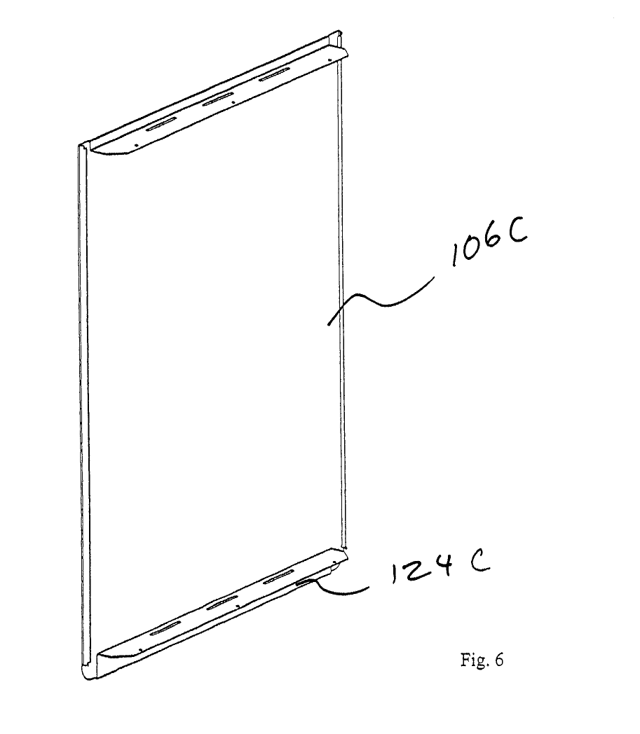

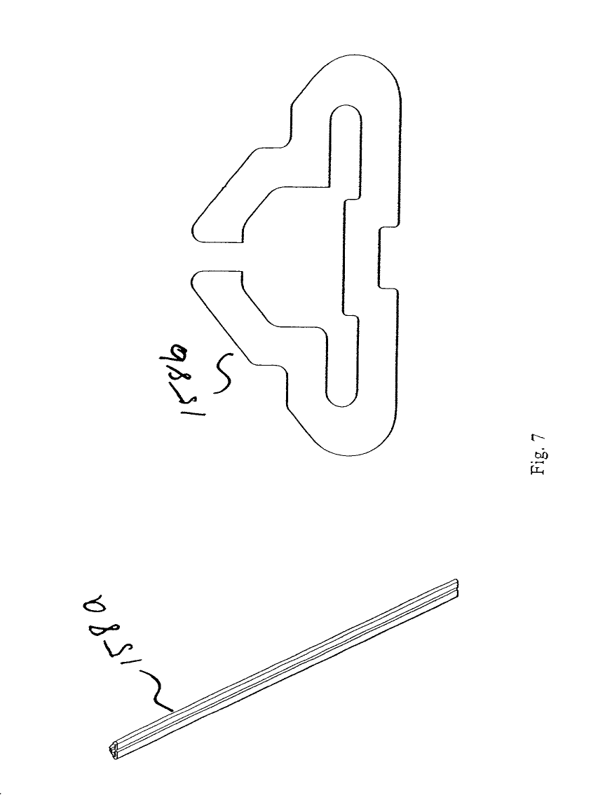

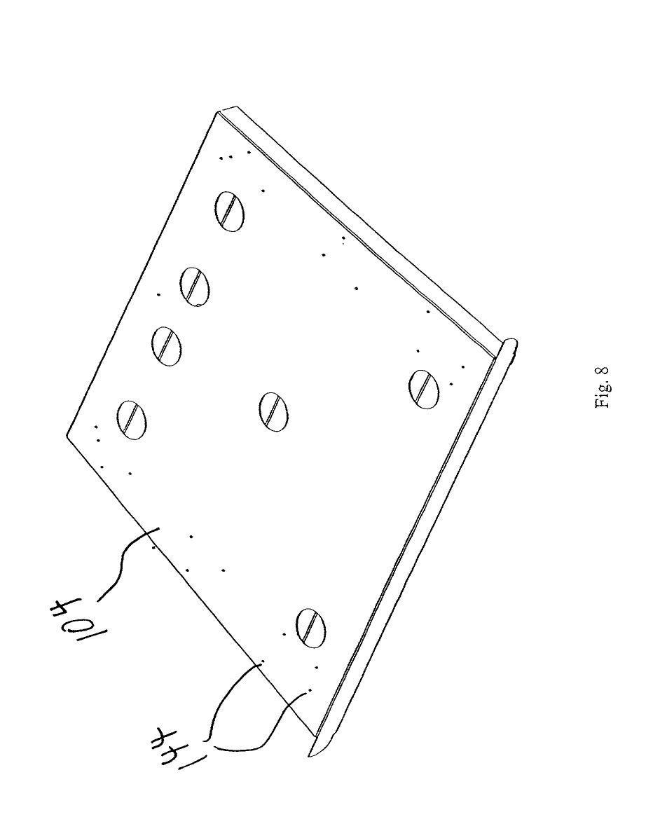

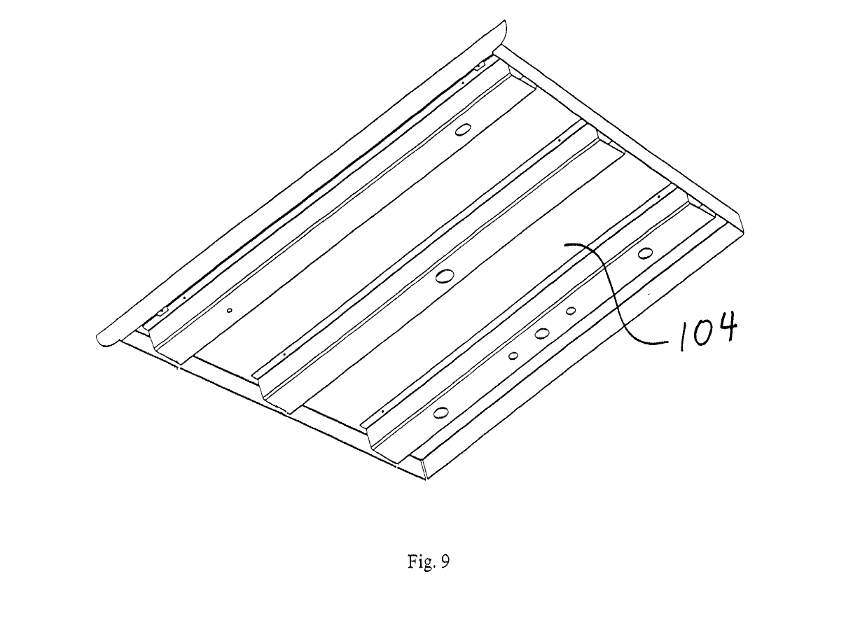

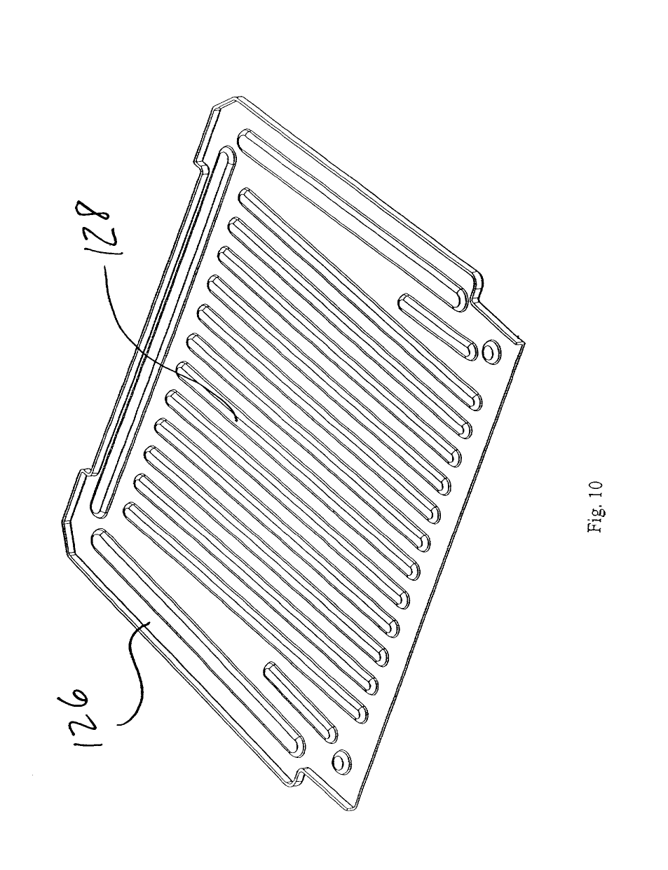

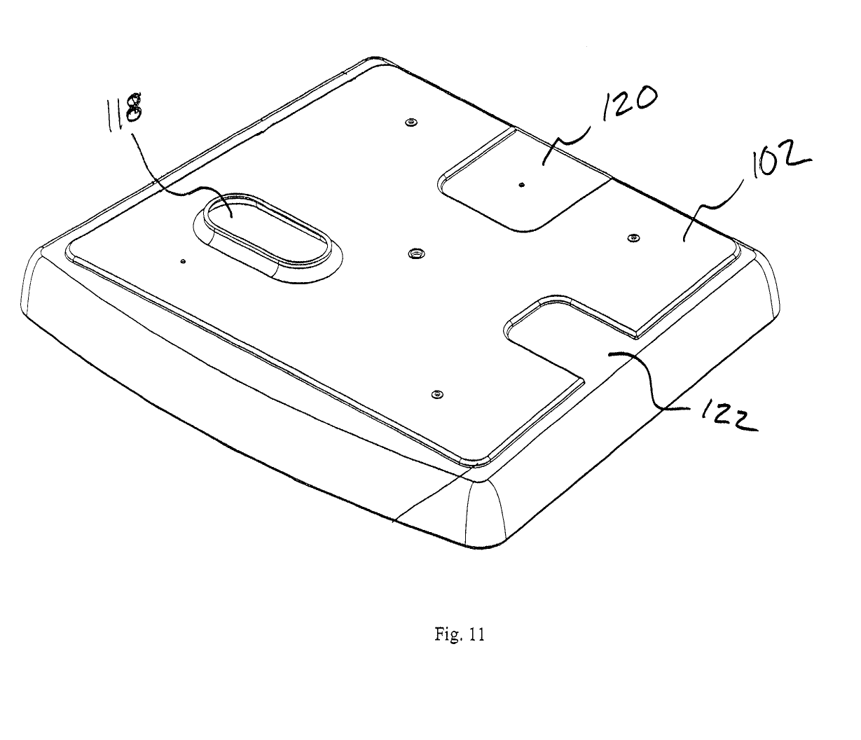

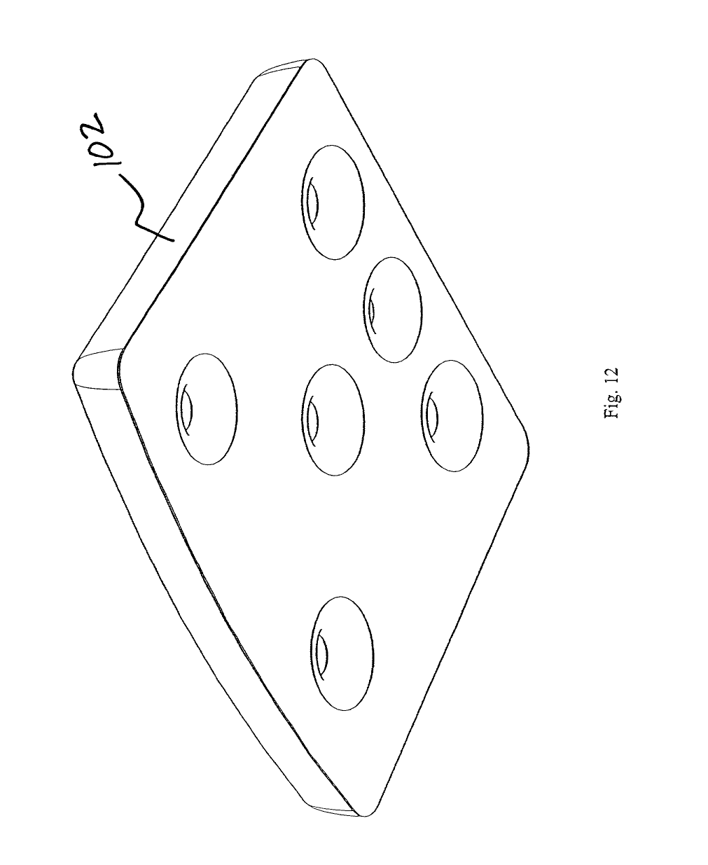

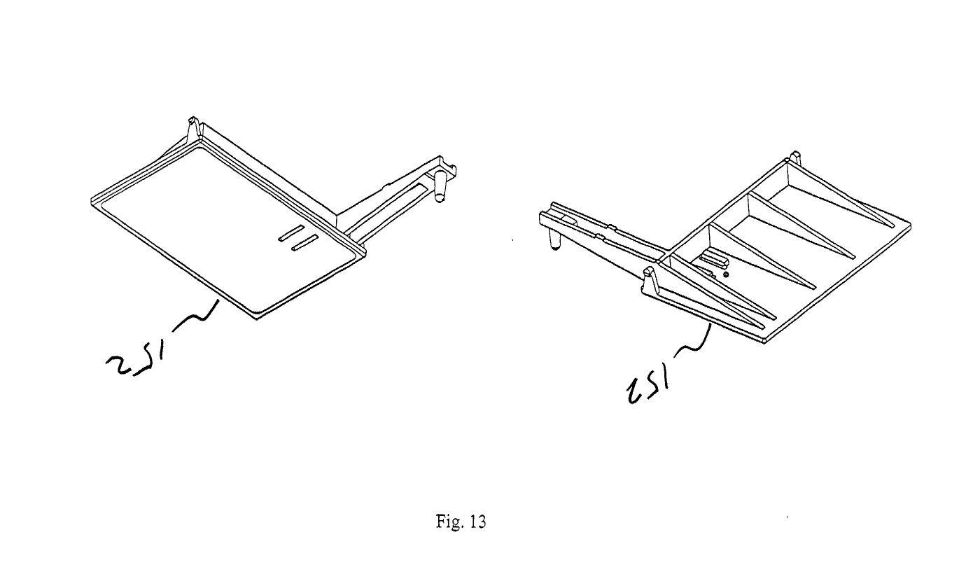

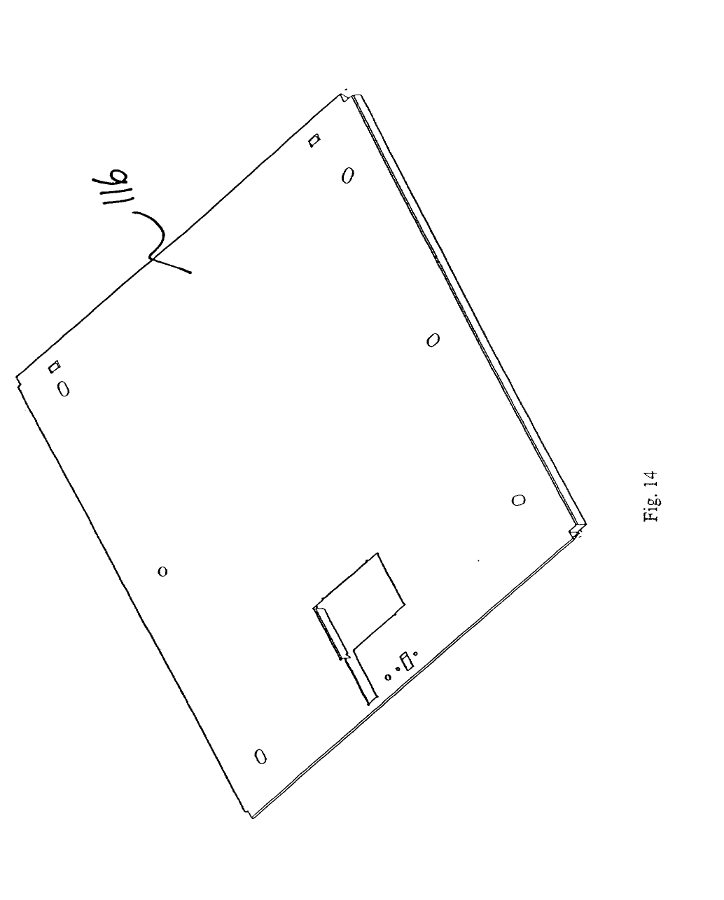

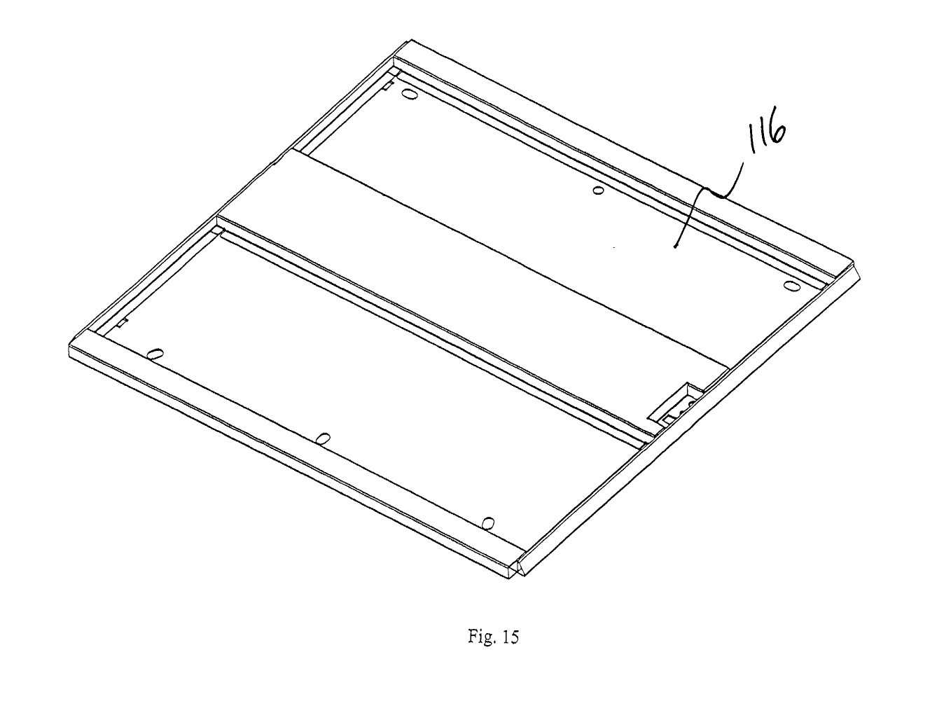

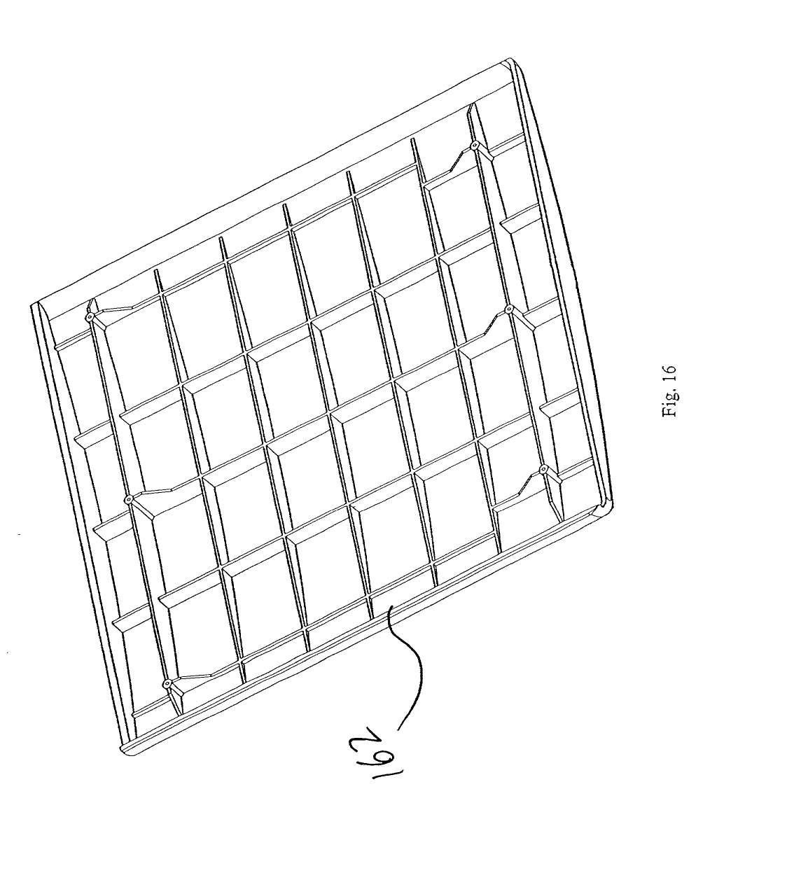

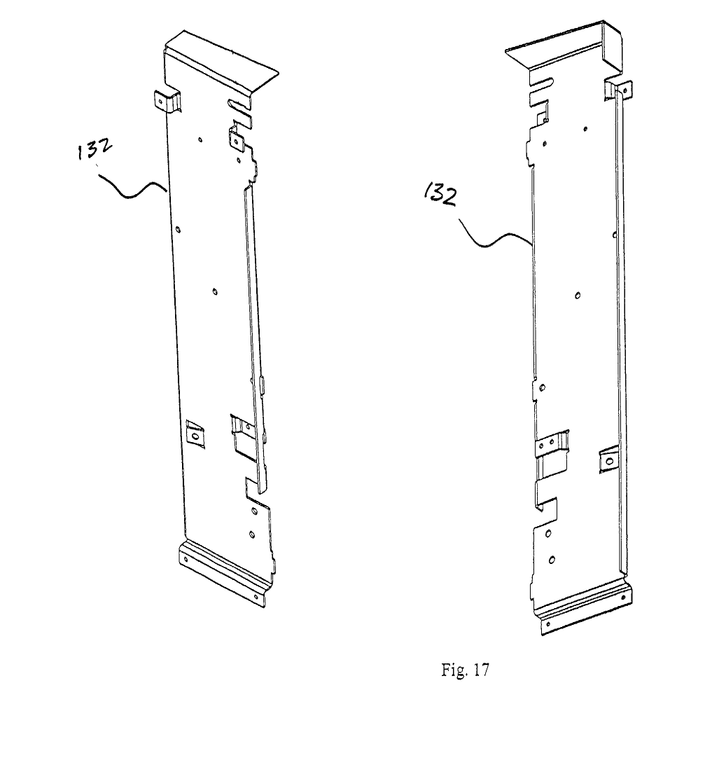

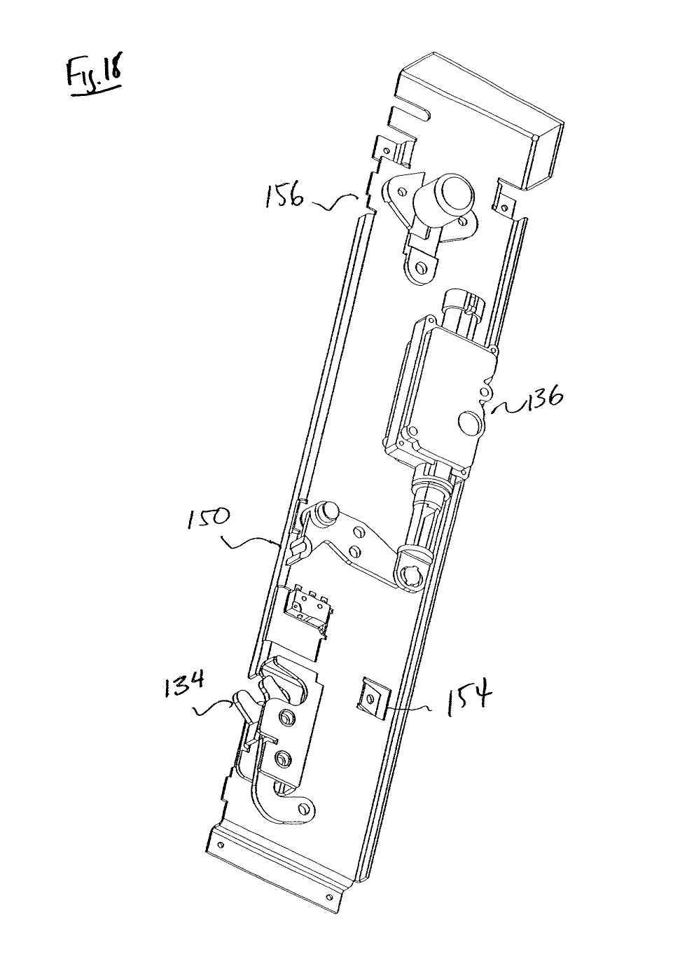

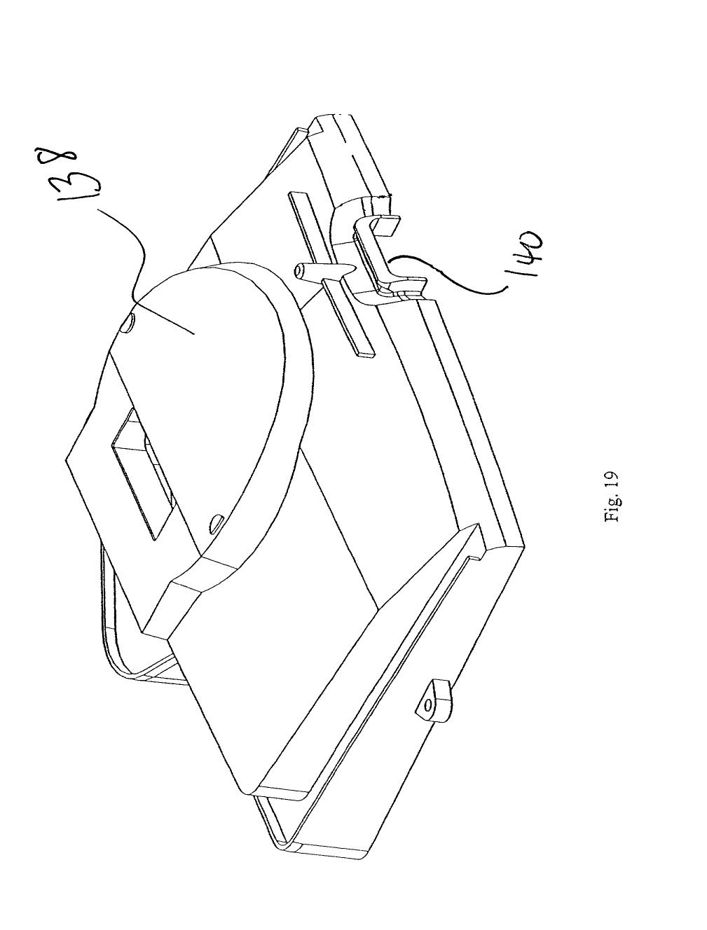

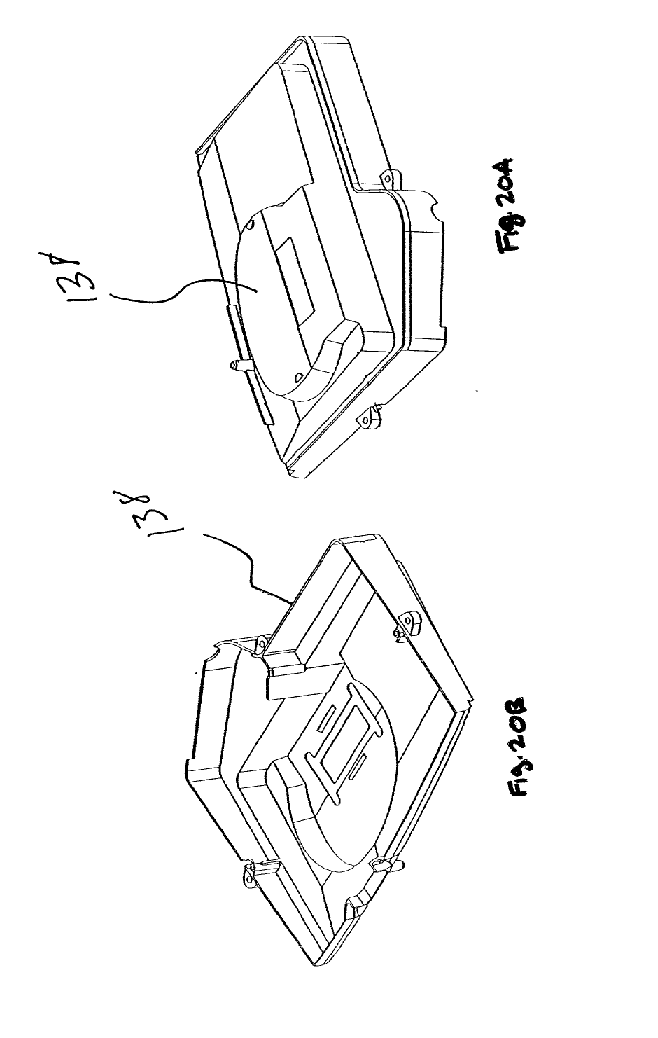

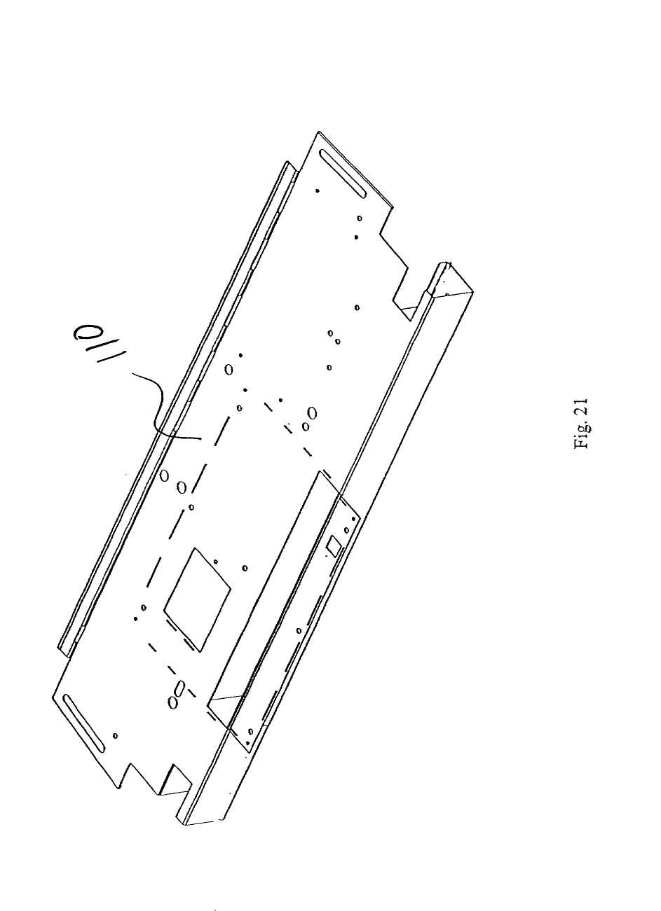

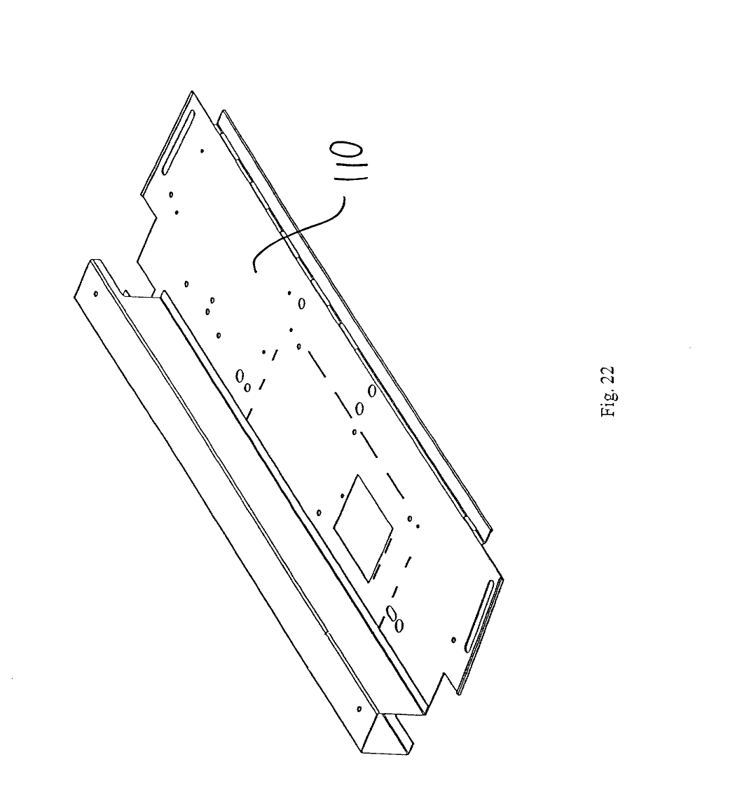

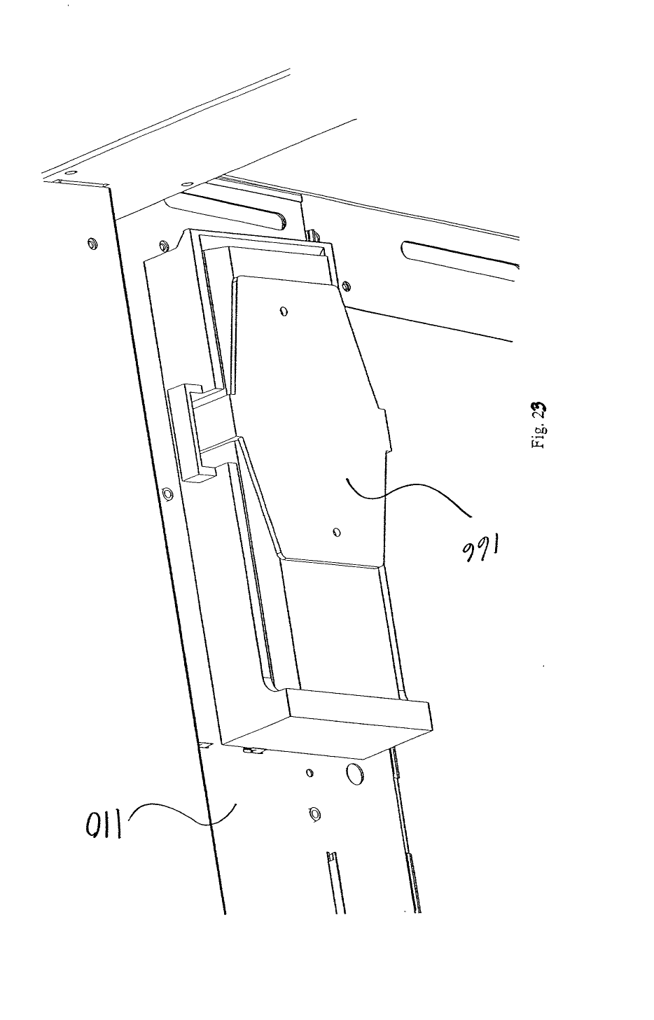

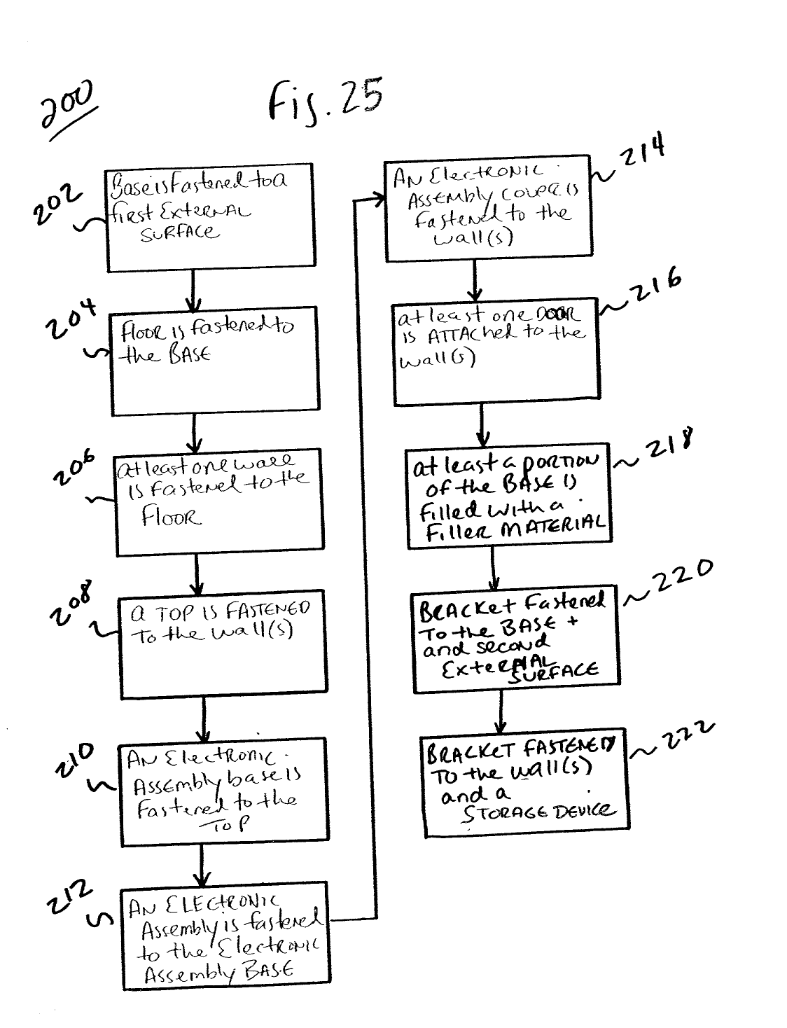

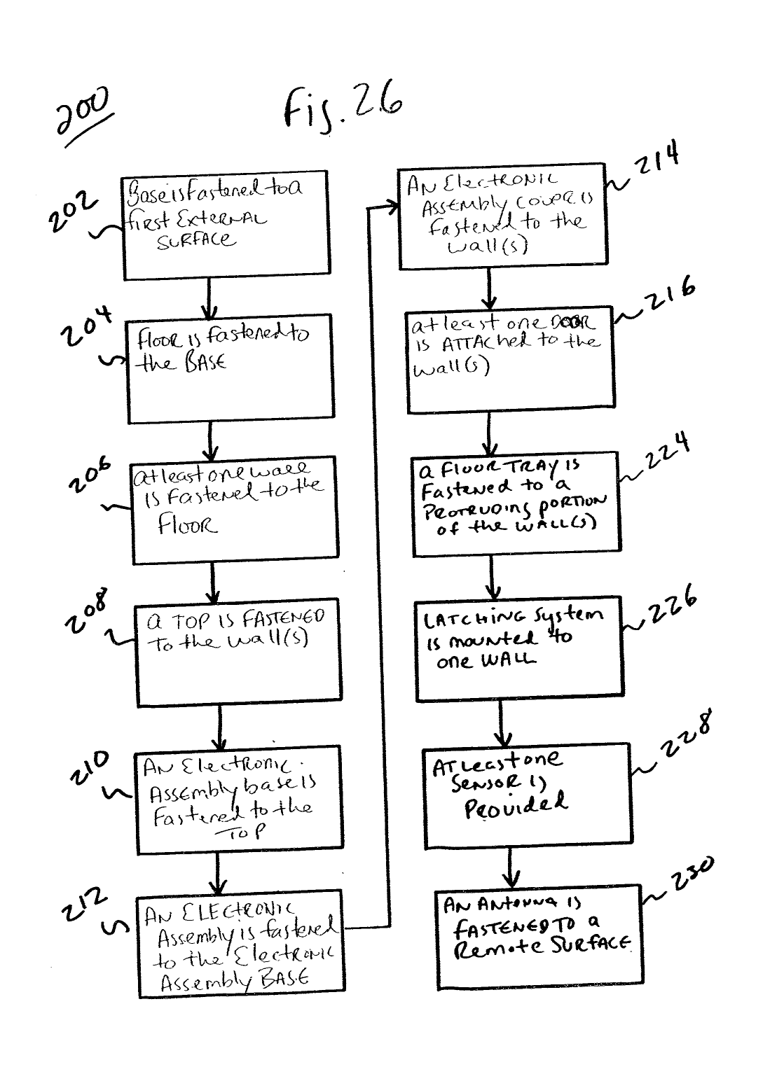

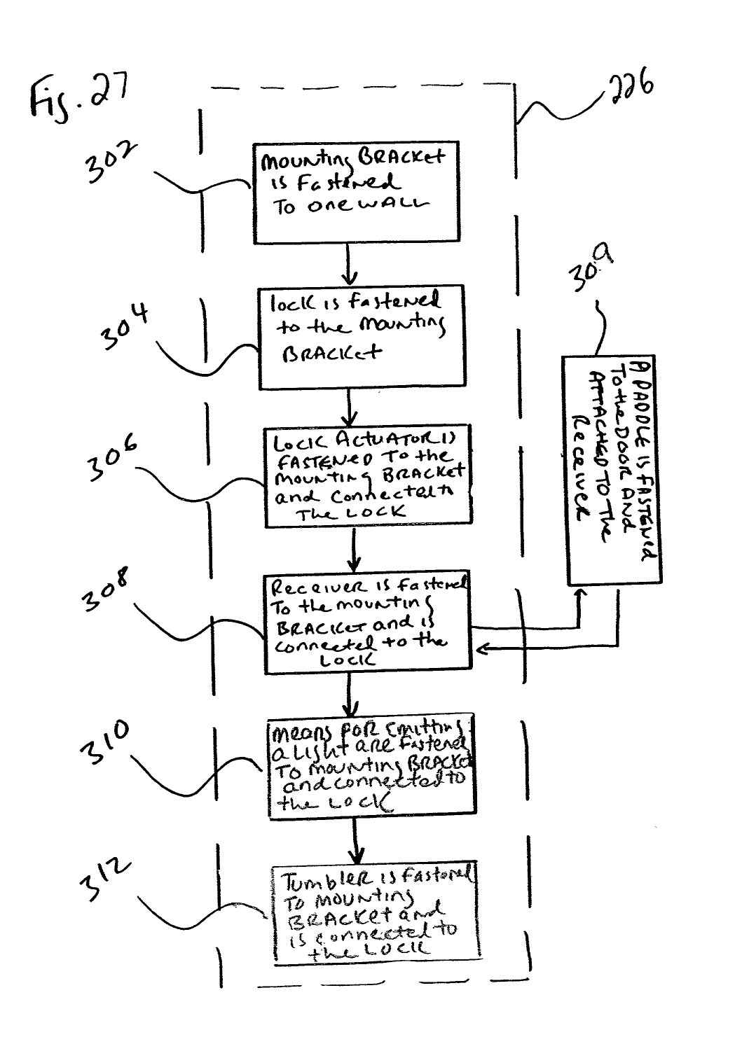

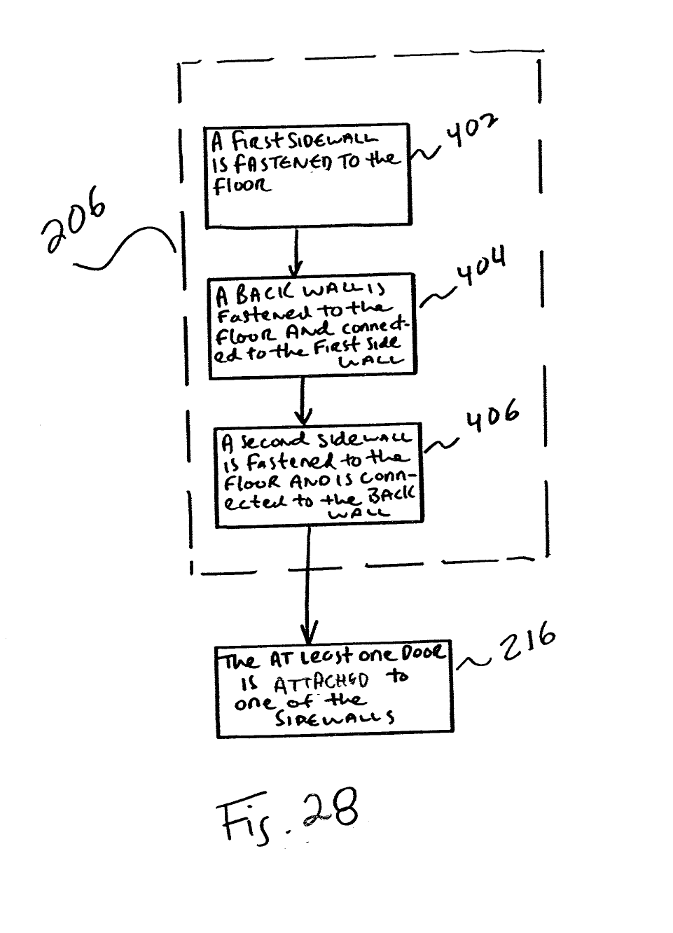

Preferred embodiments of the present invention and their advantages may be understood by referring to FIGS. 1-28, like numerals being used for like corresponding parts in the various drawings.

Referring to FIGS. 1-23, an apparatus 100 for an unattended delivery or an unattended pick-up of goods is described. Apparatus 100 may comprise a base 102, which may be manufactured from a blow-molded plastic, stamped sheet metal, or the like, in which base 102 may have a first base weight and may be fastened to an external surface, such as a patio, a deck, the ground, or the like. In one embodiment, base 102 may comprise at least one opening 118, in which a filler material, such as sand, gravel, water, or the like, may be inserted into base 102. Moreover, inserting the filler material into base 102 may increase the first base weight to a second base weight, such that it may be more difficult to move or tilt apparatus 100. Base 102 also may comprise first cutout portion 120, in which cutout portion 120 may be adapted to receive a first end of a bracket (not shown). In this embodiment, a second end of the bracket may be fastened to an external surface, such as a wall, a house, a building, or the like. In yet another embodiment, base 102 may comprise a second cutout portion 122, in which cutout portion 122 may be adapted to receive a first end of a bracket (not shown). In this embodiment, a second end of the bracket may be fastened to a storage device, such as an unattended delivery or pick-up device, a storage device, or the like, and may provide additional storage space.

Apparatus 100 also may comprise a floor 104, which may be metal, or another hard rigid material, wherein floor 104 may be fastened to base 102. Floor 104 may comprise ventilation holes 144, which may allow air-flow inside apparatus 100. Apparatus 100 also may comprise at least one wall 106, in which wall 106 may be fastened to floor 104. Moreover, wall 106 may comprise at least one protruding portion 124, in which protruding portion 124 may be located on a bottom portion of wall 106. Apparatus 100 also may comprise a floor tray 126, which may be manufactured from a durable plastic material, sheet metal, or the like, in which floor tray 126 may be fastened to protruding portion 124. Moreover, floor tray 126 may be positioned such that floor tray 126 may be suspended above floor 104, such that floor tray 126 and floor 104 do not touch. Floor tray 126 also may comprise at least one raised portion 128. If water leaks on to floor tray 126, raised portion 128 may prevent an item located inside apparatus 100 from coming in contact with the water.

In addition, wall 106 may comprise a first side wall 106a, a second side wall 106b, and a back wall 106c. In this embodiment, first side wall 106a, second side wall 106b, and back wall 106c may each be fastened to floor 104. First side wall 104a may comprise an angled end and may be connected to back wall 104c, which also may have an angled end, via a corner clip extrusion. 158. Corner clip extrusion 158 may comprise an extrusion portion 158a and a corner clip portion 158b, such that clip 158b may slide over extrusion 158a when first side wall 106a and back wall 106c are in close proximity. Corner clip extension 158 also may prevent water from entering apparatus 100. Similarly, back wall 106c also may be connected to second side wall 106b via a corner clip extrusion 158. Moreover, first side wall 106a, second side wall 106b, and back wall 106c may comprise protruding portions 124a, 124b, and 124c, respectively, and floor tray 126 may be fastened to protruding portions 124a, 124b, and 124c, such that floor tray 126 is suspended above floor 104 and floor tray 126 and floor 104 do not touch.

Apparatus 100 further may comprise a top 108, in which top 108 may be fastened to wall 106. Top 108 may be manufactured from a durable plastic, metal, or the like, and also may comprise a plurality of ventilation holes 146, which may allow air-flow through apparatus 100. Apparatus 100 also may comprise an electronic assembly base 110, in which electronic assembly base 110 may be fastened to top 108. Electronic assembly base 110 may comprise an electromagnetically insulating material. Apparatus 100 further may comprise an electronic assembly 112, in which electronic assembly 112 may be fastened to electronic assembly base 110. Moreover, electronic assembly 112 may comprise control panel 138 and infrared port 140. In this embodiment, control panel 138 may comprise a plurality of keys (not shown) and a display (not shown), in which the display may comprise at least one light source (not shown).

Apparatus 100 further may comprise an electronic assembly cover 114, in which electronic assembly cover 114 may be fastened to wall 106. Electronic assembly cover 114 may prevent water from entering apparatus 100 and may be manufactured from a durable plastic and also may be removable, such that a user may replace or change electronic assembly cover 114. Electronic assembly cover 114 may comprise a rotatable panel cover 148 and at least one recessed portion 142, in which recessed portion 142 may shield infrared port 140 from ambient light. Alternatively, electronic assembly cover 114 may comprise a filter, a mesh screen, or the like, which may reduce the effect of ambient light. Apparatus 100 also may comprise at least one door 116, in which door 116 may be attached to at least one end of wall 106. Alternatively, door 116 may be attached to at least one end of either side wall 106a or side wall 106b. In each of the above-described embodiments, door 116 may be attached to wall 106 via a hinge mechanism 160, or the like. In this embodiment, hinge mechanism 160 may comprise hinge mounting plate 160a and at least one hinge 160b. Moreover, in each of the above-described embodiments, floor 104, top 108, wall 106, and door 116 may form an enclosure. Apparatus 100 also may comprise door cover 162, which may be removable and also may be manufactured from a durable plastic, in which door cover 162 may be attached to door 116.

In each of the above-described embodiments, apparatus 100 further may comprise a latching apparatus 130, in which latching apparatus 130 may be mounted to wall 106. Latching apparatus 130 may comprise a mounting bracket 132, in which mounting bracket 132 may be fastened to wall 106. Latching apparatus 130 also may comprise a lock 134, in which lock 134 may be fastened to mounting bracket 130. Latching apparatus 130 further may comprise a lock actuator 136, in which lock actuator 136 may be fastened to mounting bracket 130 and also may be connected to lock 134 via a connector (not shown). Further, lock actuator 136 may be adapted to communicate with electronic assembly 112, such that lock 134 may open door 116 when lock actuator 136 communicates with electronic assembly 112.

Latching apparatus 130 also may comprise a receiver 150, in which receiver 150 may be fastened to mounting bracket 132 and also may be connected to lock 134 via a connector (not shown). In this embodiment, apparatus 100 further may comprise an emergency paddle 152, in which emergency paddle 152 may be fastened to door 116 and also may be attached to receiver 150. In an embodiment, at least a portion of paddle 152 may comprise a glow in the dark material, e.g., phosphorescent, florescent, or the like. Moreover, paddle 152 may comprise a biasing means (not shown), such as a coil, a leaf, a spring, or the like, in which a biasing force may be associated with the biasing means. In this embodiment, when door 116 is closed, door 116 may open when a force greater than the biasing force is applied to paddle 152. Moreover, the biasing force may be selected, such that when an item located inside apparatus 100 presses against paddle 152, the force applied by the item may be less than the biasing force, such that door 116 may not open. In addition, the biasing force also may be selected, such that a human being trapped inside apparatus 100 may apply a force to paddle 152, such that the applied force may be greater than the biasing force. In this embodiment, latching apparatus 130 also may comprise means for emitting a light 154, such as a light emitting diode, a low power light source, or the like. Light emitting means 154 may be fastened to mounting bracket 132 and also may produce a light when door 116 is closed, such that paddle 152 may be visible from the inside of apparatus 100. Latching apparatus 130 further may comprise a tumbler 156, in which tumbler 156 may be fastened to mounting bracket 132 and also may be connected to lock 134 via a connector (not shown). Moreover, tumbler 156 may be adapted to receive an externally entered key, in which lock 134 may open door 116 when the key is turned in a predetermined direction, such as right or left. Alternatively, apparatus 100 may comprise a combination lock (not shown), such that door 116 may open when a user enters a predetermined combination.

Apparatus 100 further may comprise at least one sensor (not shown). For example, the sensor may be is door open sensor, in which the door open sensor may be coupled to either door 116 or latching apparatus 130. In this embodiment, the sensor may be adapted to detect an opening of door 116. The sensor also may be an ambient temperature sensor, in which the ambient temperature sensor may be coupled to control panel 138. In this embodiment, the sensor may be adapted to detect a first ambient temperature at a first time and a second ambient temperature at a second time, and control panel 138 may be adapted to adjust a voltage of the display when the first ambient temperature does not match the second ambient temperature. The sensor further may be an ambient light sensor, in which the ambient light sensor may be coupled to control panel 138. In this embodiment, the sensor may be adapted to detect an ambient light level and the display may be adapted to activate the light source when the detected ambient light level is less than a predetermined light level. In another embodiment, the sensor may be a panel cover open sensor, in which the panel cover sensor may be coupled to control panel 138. In this embodiment, the sensor may be adapted to detect a rotation of control panel cover 148 and control panel 138 may be adapted to activate the display when control panel 148 is rotated.

Apparatus 100 may comprise battery holder device 166, in which batter holder device 166 may be fastened underneath electronic assembly base 110, and also may be adapted to provide power to electronic assembly 112. Moreover, battery holder 166 may be adapted to receive a plurality of batteries and also may be removable, such that a user of apparatus 100 may remove battery holder 166 from apparatus 100, insert the batteries into battery holder 166, and reinstall battery holder 166. Apparatus 100 also may comprise an antenna (not shown), in which the antenna may be fastened to a remote location, such as a roof of a building, a location where a signal may be received, or the like. In addition, electronic assembly 112 may comprise an interface (not shown) which may communicate with the antenna. Alternatively, electronic assembly 112 may comprise a standard telephone jack (not shown) for connecting electronic assembly 112 to a land-line telephone apparatus. Electronic assembly 122 also may comprise an interface (not shown) to allow apparatus 100 to communicate with a computer network directly or over the internet.

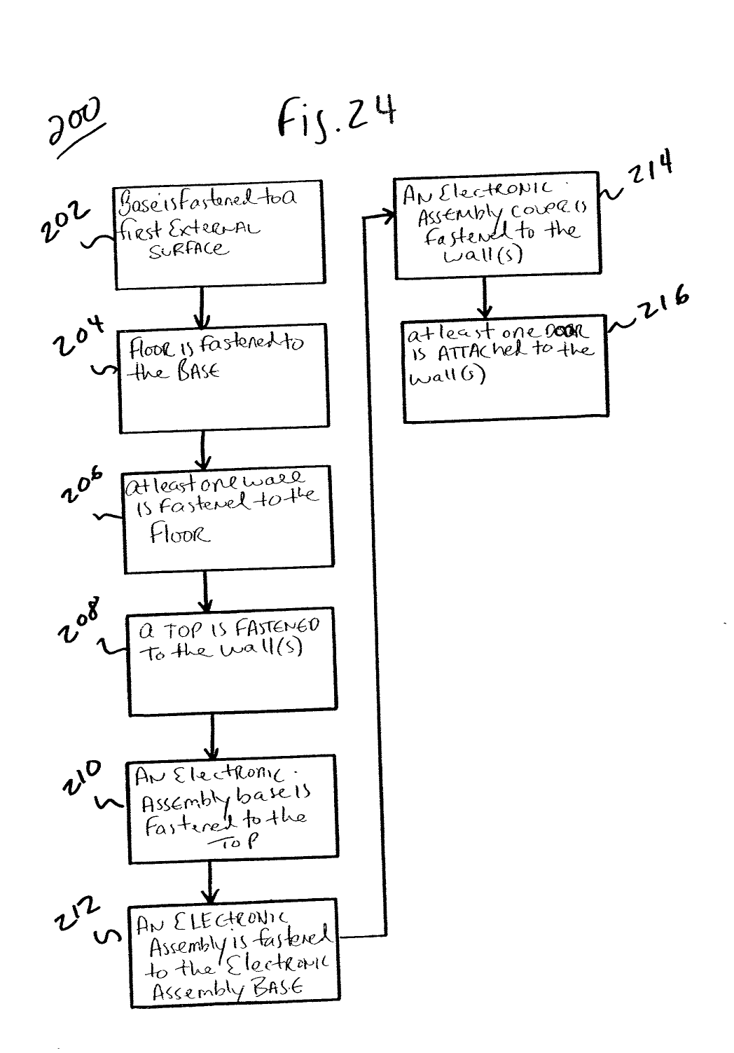

Referring to FIGS. 24-28, a method 200 for assembling an unattended delivery, or an unattended pick-up device is described. In step 202, a base 102, which may have a first base weight, may be fastened to an external surface, such as a patio, a deck, the ground, or the like. Base 102 may be manufactured from a blow-molded plastic, a stamped sheet metal, or the like. Moreover, base 102 may comprise at least one opening 118. In step 218, a filler material, such as sand, gravel, water, or the like, may be inserted into opening 118 and the first base weight may increase to a second base weight, such that it may be more difficult to move or tilt apparatus 100. Moreover, base 102 also may comprise a first cutout portion 120. In step 220, a first end of a bracket (not shown) may be fastened to cutout portion 120 and a second end of the bracket may be fastened to an external surface, such as a wall, a house, a building, or the like. In another embodiment, base 102 may comprise a second cutout portion 122. In step 222, a first end of a bracket (not shown) may be fastened to cutout portion 122 and a second end of the bracket may be fastened to a storage device, such as an unattended delivery or pick-up device, a storage device, or the like, which may provide additional storage space.

In step 204, a floor 104, which may be manufactured from a durable plastic, sheet metal, or the like, may be fastened to base 102. Floor 104 may comprise ventilation holes 144, which may allow air-flow inside apparatus 100. In step 206, at least one wall 106 may be fastened to floor 104. Moreover, wall 106 may comprise at least one protruding portion 124, in which protruding portion 124 may be located on a bottom portion of wall 106. In step 224, a floor tray 126, which may be manufactured from a durable plastic material, or the like, may be fastened to protruding portion 124. Moreover, floor tray 126 may be positioned such that floor tray 126 may be suspended above floor 104, such that floor tray 126 and floor 104 do not touch. Floor tray 126 also may comprise at least one raised portion 128. If water leaks on to floor tray 126, raised portion 128 may prevent an item located inside apparatus 100 from coming in contact with the water.

In yet another embodiment of the present invention, step 206 may comprise steps 402, 404, and 406. In step 402, a first side wall 106a may be fastened to floor 104. In step 404, back wall 106c may be fastened to floor 104 and also may be fastened to first side wall 104a via a corner clip extrusion. 158. Corner clip extrusion 158 may comprise an extrusion portion 158a and a corner clip portion 158b, such that clip 158b may slide over extrusion 158a when first side wall 106a and back wall 106c are in close proximity. Corner clip extension 158 also may prevent water from entering apparatus 100. In step 406, a second side wall 106b may be fastened to floor 104 and may be connected to back wall 106c via a corner clip extrusion 158. Moreover, first side wall 106a, second side wall 106b, and back wall 106c may comprise protruding portions 124a, 124b, and 124c, respectively, and in step 224 floor tray 126 may be fastened to protruding portions 124a, 124b, and 124c, such that floor tray 126 is suspended above 285 floor 104 and floor tray 126 and floor 104 do not touch.

In step 208, a top 108 may be fastened to wall 106. Top 108 may be metal and also may comprise a plurality of ventilation holes 146, which may allow air-flow through apparatus 100. In step 210, an electronic assembly base 110 may be fastened to top 108. Electronic assembly base 110 may comprise an electromagnetically insulating material. In step 212, an electronic assembly 112 may be fastened to electronic assembly base 110. Electronic assembly 112 may comprise control panel 138 and infrared port 140. In this embodiment, control panel 138 may comprise a plurality of keys (not shown) and a display (not shown), in which the display may comprise at least one light source (not shown). In step 214, an electronic assembly cover 114 may be fastened to wall 106. Electronic assembly cover 114 may prevent water from entering apparatus 100 and also may be manufactured from a durable plastic and also may be removable, such that a user may replace or change electronic assembly cover 114. Electronic assembly cover 114 may comprise a rotatable panel cover 148 and at least one recessed portion 142, in which recessed portion 142 may shield infrared port 140 from ambient light. Alternatively, electronic assembly cover 114 may comprise a filter, a mesh screen, or the like, which may reduce the effect of ambient light.

In step 216, at least one door 116 may be attached to at least one end of wall 106. Alternatively, in step 216, door 116 may be attached to at least one end of either side wall 106a or side wall 106b. In each of the above-described embodiments, door 116 may be attached to wall 106 via a hinge mechanism 160, or the like. In this embodiment, hinge mechanism 160 may comprise hinge mounting plate 160a and at least one hinge 160b. Moreover, in each of the above-described embodiments, floor 104, top 108, wall 106, and door 116 may form an enclosure. In addition, door cover 162, which may be removable and also may be manufactured from a durable plastic, may be attached to door 116.

In each of the above-described embodiments, in step 226, a latching apparatus 130 may be mounted to wall 106. Step 226 may also comprise steps 302, 304, 306, 308, 310, and 312. In step 302 a mounting bracket 132 may be fastened to wall 106. In step 304, a lock 134 may be fastened to mounting bracket 130. In step 306, a lock actuator 136 may be fastened to mounting bracket 130 and also may be connected to lock 134 via a connector (not shown). Further, lock actuator 136 may be adapted to communicate with (e.g., to be controlled by) electronic assembly 112, such that lock 134 may open door 116 when lock actuator 136 communicates with electronic assembly 112.

In step 308, a receiver 150 may be fastened to mounting bracket 132 and also may be connected to lock 134 via a connector (not shown). In this embodiment, in step 309, an emergency paddle 152 may be fastened to door 116 and also may be attached to receiver 150. In an embodiment, at least a portion of paddle 152 may comprise a glow in the dark (e.g., a phosphorescent, florescent, or the like) material. Moreover, paddle 152 may comprise a biasing means (not shown), such as a coil, a leaf, a spring, or the like, in which a biasing force may be associated with the biasing means. In this embodiment, when door 116 is closed, door 116 may open when a force greater than the biasing force is applied to paddle 152. Moreover, the biasing force may be selected, such that when an item located inside apparatus 100 presses against paddle 152, the force applied by the item may be less than the biasing force, such that door 116 may not open. In addition, the biasing force also may be selected, such that a human being trapped inside apparatus 100 may apply a force to paddle 152, such that the applied force may be greater than the biasing force. In this embodiment, in step 310, means for emitting a light 154, such as a light emitting diode, a low power light source, or the like, may be fastened to mounting bracket 132 and also may produce a light when door 116 is closed, such that paddle 152 may be visible from the inside of apparatus 100. In step 312, a tumbler 156 may be fastened to mounting bracket 132 and also may be connected to lock 134 via a connector (not shown). Moreover, tumbler 156 may be adapted to receive an externally entered key, in which lock 134 may open door 116 when the key is turned in a predetermined direction, such as right or left. Alternatively, apparatus 100 may comprise a combination lock (not shown), such that door 116 may open when a user enters a predetermined combination.

In step 228, at least one sensor (not shown) may be provided. For example, the sensor may be is door open sensor, in which the door open sensor may be coupled to either door 116 or latching apparatus 130. In this embodiment, the sensor may be adapted to detect an opening of door 116. Moreover, the sensor may be an ambient temperature sensor, in which the ambient temperature sensor may be coupled to control panel 138. In this embodiment, the sensor may be adapted to detect a first ambient temperature at a first time and a second ambient temperature at a second time, and control panel 138 may be adapted to adjust a voltage of the display when the first ambient temperature does not match the second ambient temperature. The sensor also may be an ambient light sensor, in which the ambient light sensor may be coupled to control panel 138. In this embodiment, the sensor may be adapted to detect an ambient light level and the display may be adapted to activate the light source when the detected ambient light level is less than a predetermined light level. The sensor further may be a panel cover open sensor, in which the panel cover sensor may be coupled to control panel 138. In this embodiment, the sensor may be adapted to detect a rotation of control panel cover 148 and control panel 138 may be adapted to activate the display when control panel 148 is rotated.

In another embodiment, a battery holder device 166 may be fastened underneath electronic assembly base 110, and also may be adapted to provide power to electronic assembly 112. Battery holder 166 may be adapted to receive a plurality of batteries and also may be removable, such that a user of apparatus 100 may remove battery holder 166 from apparatus 100, insert the batteries into battery holder 166, and reinstall battery holder 166. In still another embodiment of the invention, an antenna (not shown) may be fastened to a remote location, such as a roof of a building, a location where a signal may be received, or the like. In addition, electronic assembly 112 may comprise an interface (not shown) which may communicate with the antenna. Alternatively, electronic assembly 112 may comprise a standard telephone jack (not shown) for connecting electronic assembly 112 to a land-line telephone apparatus. Electronic assembly 122 also may comprise an interface (not shown) to allow apparatus 100 to communicate with a computer network directly or over the Internet.

While the invention has been described in connecting with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein.

What we claim is:

1. A method for assembling an unattended delivery device comprising the steps of:
fastening a base to a first external surface, wherein said base has a first base weight;
fastening a floor to said base;
fastening at least one wall to said floor;
fastening a top to said at least one wall;
fastening an electronic assembly base to said top;
fastening an electronic assembly to said electronic assembly base;
fastening an electronic assembly cover to said at least one wall; and
attaching at least one door to at least one end of said at least one wall, wherein said door, said at least one wall, said top and said floor form an enclosure.

2. The method of claim 1 further comprising the step of filling at least a portion of said base with a filler material, wherein said filler material increases said first base weight to a second base weight.

3. The method of claim 2, wherein said filler material is either sand or gravel.

4. The method of claim 2, further comprising the steps of fastening a first end of a bracket to said base and fastening a second of said bracket to a second external surface.

5. The method of claim 2, further comprising the steps of fastening a first end of a bracket to said base and fasting a second end of said bracket to a storage device.

6. The method of claim 1, wherein said at least one wall comprises at least one protruding portion, said protruding portion located on a bottom portion of said at least one wall.

7. The method of claim 6, further comprising the step of fastening a floor tray to said protruding portion.

8. The method of claim 7, wherein said floor tray is suspended above said floor.

9. The method of claim 8, wherein said floor tray comprises at least one raised portion.

10. The method of claim 1, further comprising the step of mounting a latching apparatus to said at least one wall.

11. The method of claim 10, wherein the step of mounting said latching apparatus to said at least one wall comprises the steps of:
fastening a mounting bracket to said at least one side wall;
fastening a lock to said mounting bracket;
fastening a lock actuator to said mounting bracket; and
connecting said lock actuator to said lock.

12. The method of claim 11, wherein said lock actuator is adapted to communicate with said electronic assembly and said lock opens said door when said lock actuator communicates with said electronic assembly.

13. The method of claim 12, wherein said electronic assembly base comprises an electromagnetically insulating material.

14. The method of claim 13, wherein said electronic assembly comprises a control panel and an infrared port.

15. The method of claim 14, wherein said control panel comprises a plurality of keys and a display, said display comprising at least one light source.

16. The method of claim 15, wherein said electronic assembly cover comprises a rotatable control panel cover and at least one recessed portion, said recessed portion shielding said infrared port from ambient light.

17. The method of claim 16, wherein the step of fastening said floor to said base comprises the step of providing a floor having a plurality of ventilation holes and the step of fastening a top to said at least one wall comprises the step of providing a top having a plurality of ventilation holes.

18. The method of claim 16, further comprising the step of providing at least one sensor.

19. The method of claim 16, wherein said at least one sensor is a panel cover open sensor coupled to said control panel, said sensor detecting a rotation of said control panel cover and said control panel activating said display.

20. The method of claim 16, wherein said at least one sensor is door open sensor coupled to either said at least one door or said latching apparatus, said sensor detecting an opening of said at least one door.

21. The method of claim 16, wherein said at least one sensor is an ambient temperature sensor coupled to said control panel, said sensor detecting a first ambient temperature at a first time and a second ambient temperature at a second time, said control panel adjusting a voltage of said display when said first ambient temperature does not match said second ambient temperature.

22. The method of claim 16, wherein said at least one sensor is an ambient light sensor coupled to said control panel, said sensor detecting an ambient light level and said display activating said light source when said detected ambient light level is less than a predetermined light level.

23. The method of claim 10, wherein the step of mounting said latching apparatus to said at least one wall comprises the steps of fastening a receiver to said mounting bracket and connecting said receiver to said lock.

24. The method of claim 23, further comprising the step of fastening a paddle to said at least one door and attaching said paddle to said receiver.

25. The method of claim 24, wherein said paddle comprises means for providing a biasing force and said lock opens said at least one door when a force greater than said biasing force is applied to said paddle.

26. The method of claim 25, wherein said biasing means is a spring.

27. The method of claim 25, wherein at least a portion of said paddle comprises a phosphorescent material.

28. The method of claim 25, wherein the step of mounting said latching apparatus to said at least one wall further comprises the step of fastening means for emitting a light to said mounting bracket, wherein said paddle is visible from an inside of said enclosure when said at least one door is closed.

29. The method of claim 10, wherein the step of mounting said latching apparatus to said at least one wall comprises the steps of fastening a tumbler to said mounting bracket and connecting said tumbler to said lock.

30. The method of claim 29, wherein said tumbler is adapted to receive an externally inserted key and said lock opens said at least one door when said key is turned in a predetermined direction.

31. The method of claim 1, wherein said plurality of walls comprises a first side wall, a second side wall, and at least one back wall.

32. The method of claim 31, further comprising the steps of:
fastening said first side wall to said floor;
fastening said back wall to said floor;
connecting said back wall to said first side wall;
fastening said second side wall to said floor;
connecting said second side wall to said back wall; and
attaching said at least one door to one of said side walls, wherein said door, said first side wall, said second side wall, said back wall, said floor, and said top form said enclosure.

33. The method claim 32, wherein said back wall is connected to said first side wall and said second side wall by a corner clip extrusion and said at least one door is attached to one of said side walls by a hinge mechanism.

34. The method of claim 32, further comprising the step of fastening an antenna to a remote surface, wherein said electronic assembly communicates with said antenna.

35. An apparatus for unattended delivery comprising:
a base fastened to a first external surface, wherein said base has a first base weight;
a floor fastened to said base;
at least one wall fastened to said floor;
a top fastened to said at least one wall;
an electronic assembly base fastened to said top;
an electronic assembly fastened to said electronic assembly base;
an electronic assembly cover fastened to said at least one wall; and
at least one door attached to at least one end of said at least one wall, wherein said door, said
at least one wall, said top and said floor form an enclosure.

36. The apparatus of claim 35, wherein at least a portion of said base comprises a filler material, said filler material increasing said first base weight to a second base weight.

37. The apparatus of claim 36, wherein said filler material is either sand or gravel.

38. The apparatus of claim 36, further comprising a bracket, wherein a first end of said bracket is fastened to said base and a second end of said bracket is fastened to a second external surface.

39. The apparatus of claim 36, further comprising a bracket, wherein a first end of said bracket is fastened to said base and a second end of said bracket is fastened to a storage device.

40. The apparatus of claim 35, wherein said at least one wall comprises at least one protruding portion, said protruding portion located on a bottom portion of said at least one wall.

41. The apparatus of claim 40, further comprising a floor tray, where said floor tray is fastened to said protruding portion.

42. The apparatus of claim 41, wherein said floor tray is suspended above said floor.

43. The apparatus of claim 42, wherein said floor tray comprises at least one raised portion.

44. The apparatus of claim 35, further comprising a latching apparatus mounted to said at least one wall.

45. The apparatus of claim 44, wherein said latching apparatus comprises:
a mounting bracket fastened to said at least one side wall;
a lock fastened to said mounting bracket;
a lock actuator fastened to said mounting bracket; and
a connector connecting said lock actuator to said lock.

46. The apparatus of claim 45, wherein said lock actuator is adapted to communicate with said electronic assembly and said lock opens said door when said lock actuator communicates with said electronic assembly.

47. The apparatus of claim 46, wherein said electronic assembly base comprises an electromagnetically insulating material.

48. The apparatus of claim 47, wherein said electronic assembly comprises a control panel and an infrared port.

49. The apparatus of claim 48, wherein said control panel comprises a plurality of keys and a display, said display comprising at least one light source.

50. The apparatus of claim 49, wherein said electronic assembly cover comprises a rotatable control panel cover and at least one recessed portion, said recessed portion shielding said infrared port from ambient light.

51. The apparatus of claim 50, wherein said floor is a floor having a plurality of ventilation holes and said top is a top having a plurality of ventilation holes.

52. The apparatus of claim 50, further comprising at least one sensor.

53. The apparatus of claim 52, wherein said at least one sensor is a panel cover open sensor coupled to said control panel, said sensor adapted to detect a rotation of said control panel cover and said control panel adapted to activate said display when said control panel is rotated.

54. The apparatus of claim 52, wherein said at least one sensor is door open sensor coupled to either said at least one door or said latching apparatus, said sensor adapted to detect an opening of said at least one door.

55. The apparatus of claim 52, wherein said at least one sensor is an ambient temperature sensor coupled to said control panel, said sensor adapted to detect a first ambient temperature at a first time and a second ambient temperature at a second time, said control panel adapted to adjust a voltage of said display when said first ambient temperature does not match said second ambient temperature.

56. The apparatus of claim 52, wherein said at least one sensor is an ambient light sensor coupled to said control panel, said sensor adapted to detect an ambient light level and said display adapted to activate said light source when said detected ambient light level is less than a predetermined light level.

57. The apparatus of claim 44, wherein said latching apparatus comprises a receiver fastened to said mounting bracket and connected to said lock.

58. The apparatus of claim 57, further comprising a paddle fastened to said at least one door and attached to said receiver.

59. The apparatus of claim 58, wherein said paddle comprises means for providing a biasing force and said lock opens said at least one door when a force greater than said biasing force is applied to said paddle.

60. The apparatus of claim 59, wherein said biasing means is a spring.

61. The apparatus of claim 59, wherein at least a portion of said paddle comprises a phosphorescent material.

62. The apparatus of claim 59, wherein said latching apparatus further comprises means for emitting a light fastened to said mounting bracket, wherein said paddle is visible from an inside of said enclosure when said at least one door is closed.

63. The apparatus of claim 44, wherein said latching apparatus comprises a tumbler fastened to said mounting bracket and connected to said lock.

64. The apparatus of claim 63, wherein said tumbler is adapted to receive an externally inserted key and said lock opens said at least one door when said key is turned in a predetermined direction.

65. The apparatus of claim 1, wherein said plurality of walls comprises a first side wall, a second side wall, and at least one back wall.

66. The apparatus of claim 31, wherein said first side wall is fastened to said floor, said back wall is fastened to said floor and is connected to said first side wall, said second side wall is fastened to said floor and is connected to said back wall, and said at least one door is attached to one of said side walls, wherein said door, said first side wall, said second side wall, said back wall, said floor, and said top form said enclosure.

67. The apparatus claim 66, further comprising a first corner clip extrusion and a second corner clip extrusion, wherein said first corner clip extrusion connects said back wall to said first side wall and said second corner clip extrusion connects said second side wall to said back wall.

68. The apparatus of claim 66, further comprising a hinge mechanism, wherein said hinge mechanism attaches said at least one door to one of said side walls.

69. The apparatus of claim 66, further comprising an antenna fastened to a remote surface, wherein said electronic assembly communicates with said antenna.
